(19) United States
(12) Patent Application Publication
(10) Pub. No.: US 2019/0169366 A1
(43) Pub. Date: Jun. 6, 2019

(54) SEMI-CRYSTALLINE THERMOPLASTIC POLYESTER FOR PRODUCING BIAXIALLY STRETCHED HOLLOW BODIES

(71) Applicant: ROQUETTE FRERES, Lestrem (FR)

(72) Inventors: Hélène AMEDRO, BETHUNE (FR); René SAINT-LOUP, LOMME (FR)

(21) Appl. No.: 16/321,305

(22) PCT Filed: Aug. 2, 2017
(86) PCT No.: PCT/FR2017/052169

§ 371 Date: Jan. 28, 2019

(30) Foreign Application Priority Data
Aug. 2, 2016 (FR) 16 57491

(51) Int. Cl. C08G 63/672; B29C 49/00; B29C 49/12; B29C 49/06

(52) U.S. Cl. CPC C08G 63/672; B29C 49/0005; B29K 2067/00; B29C 49/06; B29C 49/12

(57) ABSTRACT

Use of a semi-cristalline thermoplastic polyester for producing biaxially stretched hollow bodies, said polyester having at least one 1,4:3,6-dianhydrohexitol unit (A), at least one alicyclic diol unit (B) other than the 1,4:3,6-dianhydrohexitol units (A), and at least one terephthalic acid unit (C), wherein the molar ratio (A)/[(A)+(B)] is at least 0.05 and at most 0.30, said polyester being free of non-cyclic aliphatic diol units or comprising a molar amount of non-cyclic aliphatic diol units, relative to the totality of monomeric units in the polyester, of less than 5%, and with a reduced viscosity in solution (25° C.; phenol (50 wt. %): ortho-dichlorobenzene (50 wt. %); 5 g/L of polyester) greater than 50 mL/g.

### FIELD OF THE INVENTION

The present invention relates to the use of a semicrystalline thermoplastic polyester comprising at least one 1,4:3,6-dianhydrohexitol unit for producing biaxially stretched hollow bodies.

### TECHNICAL BACKGROUND OF THE INVENTION

Plastics have become inescapable in the mass production of objects. Indeed, their thermoplastic character enables these materials to be transformed at a high rate into all kinds of objects.

Certain thermoplastic aromatic polyesters have thermal properties which allow them to be used directly for the production of materials. They comprise aliphatic diol and aromatic diacid units. Among these aromatic polyesters, mention may be made of polyethylene terephthalate (PET), which is a polyester comprising ethylene glycol and terephthalic acid units, used for example in the production of films.

However, for certain applications or under certain usage conditions, it is necessary to improve certain properties, especially impact strength or else heat resistance. This is why glycol-modified PETs (PETgs) have been developed. They are generally polyesters comprising, in addition to the ethylene glycol and terephthalic acid units, cyclohexanedimethanol (CHDM) units. The introduction of this diol into the PET enables it to adapt the properties to the intended application, for example to improve its impact strength or its optical properties.

Other modified PETs have also been developed by introducing, into the polyester, 1,4:3,6-dianhydrohexitol units, especially isosorbide (PEIT). These modified polyesters have higher glass transition temperatures than the unmodified PETs or PETgs comprising CHDM. In addition, 1,4:3,6-dianhydrohexitols have the advantage of being able to be obtained from renewable resources such as starch.

Another problem with these PEITs is that they may have insufficient impact strength properties. In addition, the glass transition temperature may be insufficient for the production of certain plastic objects.

In order to improve the impact strength properties of the polyesters, it is known from the prior art to use polyesters in which the crystallinity has been reduced. As regards isosorbide-based polyesters, mention may be made of application US2012/0177854, which describes polyesters comprising terephthalic acid units and diol units comprising from 1 to 60 mol % of isosorbide and from 5 to 99% of 1,4-cyclohexanedimethanol which have improved impact strength properties. As indicated in the introductory section of this application, the aim is to obtain polymers in which the crystallinity is eliminated by the addition of comonomers, and hence in this case by the addition of 1,4-cyclohexanedimethanol. In the examples section, the production of various poly(ethylene-co-1,4-cyclohexanedimethylene-co-isosorbide)terephthalates (PECITs), and also an example of poly(l,4-cyclohexanedimethylene-co-isosorbide)terephthalate (PCIT), are described.

It may also be noted that while polymers of PECIT type have been the subject of commercial developments, this is not the case for PCITs. Indeed, their production was hitherto considered to be complex, since isosorbide has low reactivity as a secondary diol. Yoon et al. (Synthesis and Characteristics of a Biobased High-Tg Terpolyester of Isosorbide, Ethylene Glycol, and 1,4-Cyclohexane Dimethanol: Effect of Ethylene Glycol as a Chain Linker on Polymerization, Macromolecules, 2013, 46, 7219-7231) thus showed that the synthesis of PCIT is much more difficult to achieve than that of PECIT. This paper describes the study of the influence of the ethylene glycol content on the PECIT production kinetics.

In Yoon et al., an amorphous PCIT (which comprises approximately 29% isosorbide and 71% CHDM, relative to the sum of the diols) is produced to compare its synthesis and its properties with those of PECIT-type polymers. The use of high temperatures during the synthesis induces thermal degradation of the polymer formed if reference is made to the first paragraph of the Synthesis section on page 7222, this degradation especially being linked to the presence of aliphatic cyclic diols such as isosorbide. Therefore, Yoon et al. used a process in which the polycondensation temperature is limited to 270° C. Yoon et al. observed that, even increasing the polymerization time, the process also does not make it possible to obtain a polyester having a sufficient viscosity. Thus, without addition of ethylene glycol, the viscosity of the polyester remains limited, despite the use of prolonged synthesis times.

Thus, despite the modifications made to the PETs, there is still a constant need for novel polyesters having improved properties.

In the plastics field, and especially for the production of hollow bodies, it is necessary to have semicrystalline thermoplastic polyesters with improved properties, especially having a high glass transition temperature, which ultimately allow hot filling at high temperatures.

Objects produced from polymers having terephthalic acid functions, ethylene glycol units and isosorbide units and optionally another diol (for example 1,4-cyclohexanedimethanol) are known from document U.S. Pat. No. 6,126,992. All the polymers obtained thus have ethylene glycol units, since it is widely accepted that they are necessary for the incorporation of the isosorbide and to obtaining a high glass transition temperature.

Document U.S. Pat. No. 6,063,465 describes polyester containers produced from a polymer having isosorbide units, terephthalic acid units and ethylene glycol units. The containers thus produced are suitable for containing both liquids and solids. Examples 1 and 2 present the synthesis of polyester based on dimethyl terephthalate, isosorbide and ethylene glycol. The polymer obtained according to example 2 is prepared in the same way as that of example 1 but has a higher content of isosorbide.

However, the containers produced from these polymers exhibit, when they are filled at a temperature ranging up to 92° C., shrinkage of about 1% to 10%, or even worse, and deform at a temperature of 95° C., as is the case with the polymer having a higher isosorbide content (example 2).

Thus, there is currently still a need to have thermoplastic polyesters containing 1,4:3,6-dianhydrohexitol units for the production of hollow bodies, said polyesters thus having improved mechanical properties, being able to be easily formed and having high heat resistance allowing hot filling with high temperatures.

It is thus to the applicant's credit to have found that this object can, against all expectations, be achieved with a semicrystalline thermoplastic polyester based on isosorbide and not having ethylene glycol, while it was hitherto known that the latter was essential for the incorporation of said isosorbide. Indeed, by virtue of a particular viscosity and a particular ratio of units, the semicrystalline thermoplastic polyester used according to the present invention has improved properties for a use according to the invention in the production of biaxially stretched hollow bodies.

### SUMMARY OF THE INVENTION

A subject of the invention is thus the use of a semicrystalline thermoplastic polyester for producing biaxially stretched hollow bodies, said polyester comprising:
at least one 1,4:3,6-dianhydrohexitol unit (A);
at least one alicyclic diol unit (B) other than the 1,4:3,6-dianhydrohexitol units (A);
at least one terephthalic acid unit (C);
wherein the (A)/[(A)+(B)] molar ratio is at least 0.05 and at most 0.30,
   said polyester not containing any aliphatic non-cyclic diol units or comprising a molar amount of aliphatic non-cyclic diol units, relative to all the monomer units of the polyester, of less than 5%, and the reduced solution viscosity (25° C.; phenol (50% m): ortho-dichlorobenzene (50% m); 5 g/l of polyester) of said polyester being greater than 50 ml/g.

These polyesters have improved thermal and mechanical properties and especially good heat resistance, due to a high glass transition temperature, which is particularly beneficial for the production of biaxially stretched hollow bodies. Indeed, the biaxially stretched hollow bodies produced from said polyesters can in particular be hot-filled at temperatures ranging up to 105° C.

A second subject of the invention relates to a process for producing a biaxially stretched hollow body based on the semicrystalline thermoplastic polyester described above.

Finally, a third subject of the invention relates to a biaxially stretched hollow body comprising the semicrystalline thermoplastic polyester previously described.

### DETAILED DESCRIPTION OF THE INVENTION

A subject of the invention is thus the use of a semicrystalline thermoplastic polyester for producing biaxially stretched hollow bodies, said polyester comprising:
at least one 1,4:3,6-dianhydrohexitol unit (A);
at least one alicyclic diol unit (B) other than the 1,4:3,6-dianhydrohexitol units (A);
at least one terephthalic acid unit (C);
   wherein the (A)/[(A)+(B)] molar ratio is at least 0.05 and at most 0.30 and the reduced solution viscosity being greater than 50 ml/g.

The semicrystalline thermoplastic polyester is free of non-cyclic aliphatic diol units, or comprises a small amount thereof.

“Small molar amount of aliphatic non-cyclic diol units” is intended to mean, especially, a molar amount of aliphatic non-cyclic diol units of less than 5%. According to the invention, this molar amount represents the ratio of the sum of the aliphatic non-cyclic diol units, these units possibly being identical or different, relative to all the monomer units of the polyester.

“(A)/[(A)+(B)] molar ratio” is intended to mean the molar ratio of 1,4:3,6-dianhydrohexitol units (A)/sum of 1,4:3,6-dianhydrohexitol units (A) and alicyclic diol units (B) other than the 1,4:3,6-dianhydrohexitol units (A).

An aliphatic non-cyclic diol may be a linear or branched aliphatic non-cyclic diol. It may also be a saturated or unsaturated aliphatic non-cyclic diol. Aside from ethylene glycol, the saturated linear aliphatic non-cyclic diol may for example be 1,3-propanediol, 1,4-butanediol, 1,5-pentanediol, 1,6-hexanediol, 1,8-octanediol and/or 1,10-decanediol. As examples of saturated branched aliphatic non-cyclic diol, mention may be made of 2-methyl-1,3-propanediol, 2,2,4-trimethyl-1,3-pentanediol, 2-ethyl-2-butyl-1,3-propanediol, propylene glycol and/or neopentyl glycol. As an example of an unsaturated aliphatic diol, mention may be made, for example, of cis-2-butene-1,4-diol.

This molar amount of aliphatic non-cyclic diol unit is advantageously less than 1%. Preferably, the polyester is free of any aliphatic non-cyclic diol units and more preferentially it is free of ethylene glycol.

Despite the low amount of aliphatic non-cyclic diol, and hence of ethylene glycol, used for the synthesis, a semicrystalline thermoplastic polyester is surprisingly obtained which has a high reduced solution viscosity and in which the isosorbide is particularly well incorporated. Without being bound by any one theory, this would be explained by the fact that the reaction kinetics of ethylene glycol are much faster than those of 1,4:3,6-dianhydrohexitol, which greatly limits the integration of the latter into the polyester. The polyesters resulting therefrom thus have a low degree of integration of 1,4:3,6-dianhydrohexitol and consequently a relatively low glass transition temperature.

The monomer (A) is a 1,4:3,6-dianhydrohexitol and may be isosorbide, isomannide, isoidide, or a mixture thereof. Preferably, the 1,4:3,6-dianhydrohexitol (A) is isosorbide.

Isosorbide, isomannide and isoidide may be obtained, respectively, by dehydration of sorbitol, of mannitol and of iditol. As regards isosorbide, it is sold by the applicant under the brand name Polysorb® P.

The alicyclic diol (B) is also referred to as aliphatic and cyclic diol. It is a diol which may especially be chosen from 1,4-cyclohexanedimethanol, 1,2-cyclohexanedimethanol, 1,3-cyclohexanedimethanol or a mixture of these diols. Preferentially, the alicyclic diol (B) is 1,4-cyclohexanedimethanol.

The alicyclic diol (B) may be in the cis configuration, in the trans configuration, or may be a mixture of diols in the cis and trans configurations.

The molar ratio of 1,4:3,6-dianhydrohexitol units (A)/sum of 1,4:3,6-dianhydrohexitol units (A) and alicyclic diol units (B) other than the 1,4:3,6-dianhydrohexitol units (A), i.e. (A)/[(A)+(B)] at least 0.05 and at most 0.30. Advantageously, this ratio is at least 0.1 and most 0.28 more particularly this ratio is at least 0.15 and most 0.25.

A semicrystalline thermoplastic polyester that is particularly suitable for the production of biaxially stretched hollow bodies comprises:
a molar amount of 1,4:3,6-dianhydrohexitol units (A) ranging from 2.5 to 14 mol %;
a molar amount of alicyclic diol units (B) other than the 1,4:3,6-dianhydrohexitol units (A) ranging from 31 to 42.5 mol %;
a molar amount of terephthalic acid units (C) ranging from 45 to 55 mol %.

The amounts of different units in the polyester may be determined by 1H NMR or by chromatographic analysis of the mixture of monomers resulting from complete hydrolysis or methanolysis of the polyester, preferably by 1H NMR.

Those skilled in the art can readily find the analysis conditions for determining the amounts of each of the units of the polyester. For example, from an NMR spectrum of a poly(1,4-cyclohexanedimethylene-co-isosorbide terephthalate), the chemical shifts relating to the 1,4-cyclohexanedimethanol are between 0.9 and 2.4 ppm and 4.0 and 4.5 ppm, the chemical shifts relating to the terephthalate ring are between 7.8 and 8.4 ppm and the chemical shifts relating to the isosorbide are between 4.1 and 5.8 ppm. The integration of each signal makes it possible to determine the amount of each unit of the polyester.

The semicrystalline thermoplastic polyesters used according to the invention have a melting point ranging from 210 to 295° C., for example from 240 to 285° C.

Furthermore, the semicrystalline thermoplastic polyesters have a glass transition temperature ranging from 85 to 120° C., for example from 90 to 115° C.

The glass transition temperatures and melting points are measured by conventional methods, especially using differential scanning calorimetry (DSC) using a heating rate of 10° C./min. The experimental protocol is described in detail in the examples section below.

Advantageously, the semicrystalline thermoplastic polyester has a heat of fusion of greater than 10 J/g, preferably greater than 20 J/g, the measurement of this heat of fusion consisting in subjecting a sample of this polyester to a heat treatment at 170° C. for 16 hours, then in evaluating the heat of fusion by DSC by heating the sample at 10° C./min.

The semicrystalline thermoplastic polyester according to the invention in particular has a lightness L* greater than 40. Advantageously, the lightness L* is greater than 55, preferably greater than 60, most preferentially greater than 65, for example greater than 70. The parameter L* may be determined using a spectrophotometer, via the CIE Lab model.

Finally, the reduced solution viscosity of said semicrystalline thermoplastic polyester is greater than 50 ml/g and preferably less than 120 ml/g, this viscosity being able to be measured using an Ubbelohde capillary viscometer at 25° C. in an equi-mass mixture of phenol and ortho-dichlorobenzene after dissolving the polymer at 130° C. with stirring, the concentration of polymer introduced being 5 g/l.

This test for measuring reduced solution viscosity is, due to the choice of solvents and the concentration of the polymers used, perfectly suited to determining the viscosity of the viscous polymer prepared according to the process described below.

The semicrystalline nature of the thermoplastic polyesters used according to the present invention is characterized when the latter, after a heat treatment of 16 h at 170° C., have X-ray diffraction lines or an endothermic melting peak in differential scanning calorimetry (DSC) analysis

The semicrystalline thermoplastic polyester as defined above has many advantages for the production of biaxially stretched hollow bodies.

Indeed, by virtue in particular of the molar ratio of 1,4:3,6-dianhydrohexitol units (A)/sum of 1,4:3,6-dianhydrohexitol units (A) and alicyclic diol units (B) other than the 1,4:3,6-dianhydrohexitol units (A) of at least 0.05 and at most 0.30 and a reduced solution viscosity greater than 50 ml/g and preferably less than 120 ml/g, the semicrystalline thermoplastic polyesters have a better heat resistance, which allows the hollow bodies produced from said polyesters to be able in particular to be hot-filled at temperatures ranging up to 95° C., or even up to 105° C., without deforming and without leaking.

For the purposes of the present invention, a biaxially stretched hollow body is a hollow body essentially consisting of plastic and may for example be a bottle, a flask, a can, a barrel or a tank. The hollow body is preferably a bottle.

The biaxially stretched hollow bodies according to the invention may be directly produced from the melt state after polymerization of the semicrystalline thermoplastic polyester.

According to one alternative, the semicrystalline thermoplastic polyester may be packaged in a form that is easy to handle, such as pellets or granules, before being used for producing hollow bodies. Preferentially, the semicrystalline thermoplastic polyester is packaged in the form of granules, said granules being advantageously dried before conversion into the hollow body form The drying is carried out so as to obtain granules having a residual moisture content of less than 300 ppm, preferentially less than 200 ppm, for instance approximately 134 ppm.

The biaxially stretched hollow bodies may be produced by techniques known to those skilled in the art, such as, for example, extrusion biaxial-stretch blow molding, or injection stretch blow molding.

The production is preferably carried out by injection stretch blow molding. According to this method, the semicrystalline thermoplastic polyester is injected so as to form a preform. The neck of the preform already has its definitive shape and constitutes the part which is used to hold the future hollow body during the blow molding operation. If necessary, the preform is reheated and enclosed in a blow-molding mold having the desired shape. The mold may be formed from two half-shells having imprints on the inner face making it possible to give the future hollow body particular surface appearances.

When the preform is introduced into the mold, a stretching rod stretches the material axially, and pre-blow molding is carried out at a pressure of a few bar. The final blow molding is carried out by injection of compressed air. Thus, the polymer chains are oriented both along a longitudinal axis of the future hollow body and radially, and the polyester cools on contact with the mold, thereby fixing the hollow body in its final shape. This biaxial orientation makes it possible to obtain biaxially oriented hollow bodies with improved mechanical properties.

The shape and the volume of the hollow body depend on the characteristics of the mold used for the blow molding. Regarding the volume, it may vary from a few cm³ to a few dm³, especially from 50 cm³ to 5000 cm³ and preferably from 100 cm³ to 2500 cm³, and even more particularly from 500 cm³ to 2000 cm³, such as, for example, 1500 cm³.

According to one particular embodiment, the semicrystalline thermoplastic polyester previously defined is used in combination with one or more additional polymers for producing biaxially stretched hollow bodies.

The additional polymer may be chosen from polyamides, polyesters other than the polyester according to the invention, polystyrene, styrene copolymers, styrene-acrylonitrile copolymers, styrene-acrylonitrile-butadiene copolymers, poly(methyl methacrylate)s, acrylic copolymers, poly(ether-imide)s, poly(phenylene oxide)s such as poly(2,6-dimethylphenylene oxide), poly(phenylene sulfate)s, poly(ester-carbonate)s, polycarbonates, polysulfones, polysulfone ethers, polyether ketones, and blends of these polymers.

The additional polymer may also be a polymer which makes it possible to improve the impact properties of the polymer, especially functional polyolefins such as functionalized ethylene or propylene polymers and copolymers, core-shell copolymers or block copolymers.

One or more additives may be added during the production of biaxially stretched hollow bodies from the semicrystalline thermoplastic polyester in order to give it particular properties.

Thus, by way of example of an additive, mention may be made of opacifiers, dyes and pigments. They may be chosen from cobalt acetate and the following compounds: HS-325 Sandoplast® Red BB (which is a compound bearing an azo function, also known under the name Solvent Red 195), HS-510 Sandoplast® Blue 2B which is an anthraquinone, Polysynthren® Blue R, and Clariant® RSB Violet.

The additive may also be a UV-resistance agent such as, for example, molecules of benzophenone or benzotriazole type, such as the Tinuvin™ range from BASF: tinuvin 326, tinuvin P or tinuvin 234, for example, or hindered amines such as the Chimassorb™ range from BASF: Chimassorb 2020, Chimassorb 81 or Chimassorb 944, for example.

The additive may also be a fire-proofing agent or flame retardant, such as, for example, halogenated derivatives or non-halogenated flame retardants (for example phosphorus-based derivatives such as Exolit® OP) or such as the range of melamine cyanurates (for example melapur™: melapur 200), or else aluminum or magnesium hydroxides.

The use according to the present invention of semicrystalline thermoplastic polyester for producing biaxially stretched hollow bodies is particularly advantageous.

This is because the biaxially stretched hollow bodies thus produced from semicrystalline thermoplastic polyester as previously described, with in particular a molar ratio of 1,4:3,6-dianhydrohexitol units (A)/sum of 1,4:3,6-dianhydrohexitol units (A) and alicyclic diol units (B) other than the 1,4:3,6-dianhydrohexitol units (A) of at least 0.05 and at most 0.30 and a reduced solution viscosity of greater than 50 ml/g, have notable properties, in particular with regard to hot filling.

Thus, the biaxially stretched hollow bodies can be hot-filled, without deforming or leaking, up to temperatures of 105° C.

A second subject of the invention relates to a process for producing a biaxially stretched hollow body, said process comprising the following steps of:
provision of a semicrystalline thermoplastic polyester as defined below;
preparation of said biaxially oriented hollow body from the semicrystalline thermoplastic polyester obtained in the preceding step.

The preparation step can be carried out according to the methods known to those skilled in the art which are conventionally implemented for producing biaxially stretched hollow bodies.

Thus, by way of example, the preparation can be carried out by extrusion biaxial-stretch blow molding or by injection stretch blow molding. The production is preferably carried out by injection stretch blow molding.

A third subject of the invention relates to biaxially stretched hollow bodies comprising the semicrystalline thermoplastic polyester described above. The biaxially stretched hollow bodies according to the invention may also comprise an additional polymer and/or one or more additives as defined above.

The semicrystalline thermoplastic polyester that is particularly suitable for producing biaxially stretched hollow bodies may be prepared by a synthesis process comprising:
a step of introducing, into a reactor, monomers comprising at least one 1,4:3,6-dianhydrohexitol (A), at least one alicyclic diol (B) other than the 1,4:3,6-dianhydrohexitols (A) and at least one terephthalic acid (C), the molar ratio ((A)+(B))/(C) ranging from 1.05 to 1.5, said monomers not containing any aliphatic non-cyclic diols or comprising, relative to all of the monomers introduced, a molar amount of aliphatic non-cyclic diol units of less than 5%;
a step of introducing a catalytic system into the reactor;
a step of polymerizing said monomers to form the polyester, said step consisting of:
   a first stage of oligomerization, during which the reaction medium is stirred under an inert atmosphere at a temperature ranging from 265 to 280° C., advantageously from 270 to 280° C., for example 275° C.;
   a second stage of condensation of the oligomers, during which the oligomers formed are stirred under vacuum, at a temperature ranging from 278 to 300° C. so as to form the polyester, advantageously from 280 to 290° C., for example 285° C.;
a step of recovering the semicrystalline thermoplastic polyester.

This first stage of the process is carried out in an inert atmosphere, that is to say under an atmosphere of at least one inert gas. This inert gas may especially be dinitrogen. This first stage may be carried out under a gas stream and it may also be carried out under pressure, for example at a pressure of between 1.05 and 8 bar.

Preferably, the pressure ranges from 3 to 8 bar, most preferentially from 5 to 7.5 bar, for example 6.6 bar. Under these preferred pressure conditions, the reaction of all the monomers with one another is promoted by limiting the loss of monomers during this stage.

Prior to the first stage of oligomerization, a step of deoxygenation of the monomers is preferentially carried out. It can be carried out for example once the monomers have been introduced into the reactor, by creating a vacuum then by introducing an inert gas such as nitrogen thereto. This vacuum-inert gas introduction cycle can be repeated several times, for example from 3 to 5 times. Preferably, this vacuum-nitrogen cycle is carried out at a temperature of between 60 and 80° C. so that the reagents, and especially the diols, are totally molten. This deoxygenation step has the advantage of improving the coloration properties of the polyester obtained at the end of the process.

The second stage of condensation of the oligomers is carried out under vacuum. The pressure may decrease continuously during this second stage by using pressure decrease ramps, in steps, or else using a combination of pressure decrease ramps and steps. Preferably, at the end of this second stage, the pressure is less than 10 mbar, most preferentially less than 1 mbar.

The first stage of the polymerization step preferably has a duration ranging from 20 minutes to 5 hours. Advantageously, the second stage has a duration ranging from 30 minutes to 6 hours, the beginning of this stage consisting of the moment at which the reactor is placed under vacuum, that is to say at a pressure of less than 1 bar.

The process also comprises a step of introducing a catalytic system into the reactor. This step may take place beforehand or during the polymerization step described above.

Catalytic system is intended to mean a catalyst or a mixture of catalysts, optionally dispersed or fixed on an inert support.

The catalyst is used in amounts suitable for obtaining a high-viscosity polymer in accordance with the use according to the invention for the production of hollow bodies.

An esterification catalyst is advantageously used during the oligomerization stage. This esterification catalyst can be chosen from derivatives of tin, titanium, zirconium, hafnium, zinc, manganese, calcium and strontium, organic catalysts such as para-toluenesulfonic acid (PTSA) or methanesulfonic acid (MSA), or a mixture of these catalysts. By way of example of such compounds, mention may be made of those given in application US 2011282020A1 in paragraphs [0026] to [0029], and on page 5 of application WO 2013/062408 A1.

Preferably, a zinc derivative or a manganese, tin or germanium derivative is used during the first stage of transesterification.

By way of example of amounts by weight, use may be made of from 10 to 500 ppm of metal contained in the catalytic system during the oligomerization stage, relative to the amount of monomers introduced.

At the end of transesterification, the catalyst from the first step can be optionally blocked by adding phosphorous acid or phosphoric acid, or else, as in the case of tin(IV), reduced with phosphites such as triphenyl phosphite or tris(nonylphenyl) phosphites or those cited in paragraph [0034] of application US 2011 282020A1.

The second stage of condensation of the oligomers may optionally be carried out with the addition of a catalyst. This catalyst is advantageously chosen from tin derivatives, preferentially derivatives of tin, titanium, zirconium, germanium, antimony, bismuth, hafnium, magnesium, cerium, zinc, cobalt, iron, manganese, calcium, strontium, sodium, potassium, aluminum or lithium, or of a mixture of these catalysts. Examples of such compounds may for example be those given in patent EP 1 882 712 B1 in paragraphs [0090] to [0094].

Preferably, the catalyst is a tin, titanium, germanium, aluminum or antimony derivative.

By way of example of amounts by weight, use may be made of from 10 to 500 ppm of metal contained in the catalytic system during the stage of condensation of the oligomers, relative to the amount of monomers introduced.

Most preferentially, a catalytic system is used during the first stage and the second stage of polymerization. Said system advantageously consists of a catalyst based on tin or of a mixture of catalysts based on tin, titanium, germanium and aluminum.

By way of example, use may be made of an amount by weight of 10 to 500 ppm of metal contained in the catalytic system, relative to the amount of monomers introduced.

According to the preparation process, an antioxidant is advantageously used during the step of polymerization of the monomers. These antioxidants make it possible to reduce the coloration of the polyester obtained. The antioxidants may be primary and/or secondary antioxidants. The primary antioxidant may be a sterically hindered phenol, such as the compounds Hostanox® 0 3, Hostanox® 0 10, Hostanox® 0 16, Ultranox® 210, Ultranox® 276, Dovernox® 10, Dovernox® 76, Dovernox® 3114, Irganox® 1010 or Irganox® 1076 or a phosphonate such as Irgamod® 195. The secondary antioxidant may be trivalent phosphorus compounds such as Ultranox® 626, Doverphos® S-9228, Hostanox® P-EPQ or Irgafos 168.

It is also possible to introduce as polymerization additive into the reactor at least one compound that is capable of limiting unwanted etherification reactions, such as sodium acetate, tetramethylammonium hydroxide or tetraethylammonium hydroxide.

Finally, the synthesis process comprises a step of recovering the polyester resulting from the polymerization step. The semicrystalline thermoplastic polyester thus recovered can then be formed as described above.

According to one variant of the synthesis process, a step of increasing the molar mass is carried out after the step of recovering the semicrystalline thermoplastic polyester.

The step of increasing the molar mass is carried out by post-polymerization and may consist of a step of solid-state polycondensation (SSP) of the semicrystalline thermoplastic polyester or of a step of reactive extrusion of the semicrystalline thermoplastic polyester in the presence of at least one chain extender.

Thus, according to a first variant of the production process, the post-polymerization step is carried out by SSP.

SSP is generally carried out at a temperature between the glass transition temperature and the melting point of the polymer. Thus, in order to carry out the SSP, it is necessary for the polymer to be semicrystalline. Preferably the latter has a heat of fusion of greater than 10 J/g, preferably greater than 20 J/g, the measurement of this heat of fusion consisting in subjecting a sample of this polymer of lower reduced solution viscosity to a heat treatment at 170° C. for 16 hours, then in evaluating the heat of fusion by DSC by heating the sample at 10 K/min.

Advantageously, the SSP step is carried out at a temperature ranging from 190 to 280° C., preferably ranging from 200 to 250° C., this step imperatively having to be carried out at a temperature below the melting point of the semicrystalline thermoplastic polyester.

The SSP step may be carried out in an inert atmosphere, for example under nitrogen or under argon or under vacuum.

According to a second variant of the production process, the post-polymerization step is carried out by reactive extrusion of the semicrystalline thermoplastic polyester in the presence of at least one chain extender.

The chain extender is a compound comprising two functions capable of reacting, in reactive extrusion, with alcohol, carboxylic acid and/or carboxylic acid ester functions of the semicrystalline thermoplastic polyester. The chain extender may, for example, be chosen from compounds comprising two isocyanate, isocyanurate, lactam, lactone, carbonate, epoxy, oxazoline and imide functions, it being possible for said functions to be identical or different. The chain extension of the thermoplastic polyester may be carried out in any of the reactors capable of mixing a very viscous medium with stirring that is sufficiently dispersive to ensure a good interface between the molten material and the gaseous headspace of the reactor. A reactor that is particularly suitable for this treatment step is extrusion.

The reactive extrusion may be carried out in an extruder of any type, especially a single-screw extruder, a co-rotating twin-screw extruder or a counter-rotating twin-screw extruder. However, it is preferred to carry out this reactive extrusion using a co-rotating extruder.

The reactive extrusion step may be carried out by:
introducing the polymer into the extruder so as to melt said polymer;
then introducing the chain extender into the molten polymer;
then reacting the polymer with the chain extender in the extruder;
then recovering the semicrystalline thermoplastic polyester obtained in the extrusion step.

During the extrusion, the temperature inside the extruder is adjusted so as to be at a above the melting point of the polymer. The temperature inside the extruder may range from 150 to 320° C.

The invention will be understood more clearly by means of the examples below, which are intended to be purely illustrative and do not in any way limit the scope of the protection.

### EXAMPLES

The properties of the polymers were studied via the following techniques:

### Reduced Solution Viscosity

The reduced solution viscosity is evaluated using an Ubbelohde capillary viscometer at 25° C. in an equi-mass mixture of phenol and ortho-dichlorobenzene after dissolving the polymer at 130° C. with stirring, the concentration of the polymer introduced being 5 g/l.

### DSC

The thermal properties of the polyesters were measured by differential scanning calorimetry (DSC): The sample is first heated under a nitrogen atmosphere in an open crucible from 10° C. to 320° C. (10° C.·min⁻¹), cooled to 10° C. (10° C.·min⁻¹), then heated again to 320° C. under the same conditions as the first step. The glass transition temperatures were taken at the mid-point of the second heating. Any melting points are determined on the endothermic peak (onset) at the first heating.

Similarly, the enthalpy of fusion (area under the curve) is determined at the first heating.

For the illustrative examples presented below, the following reagents were used:

1,4-Cyclohexanedimethanol (99% purity, mixture of cis and trans isomers)
Isosorbide (purity >99.5%) Polysorb® P from Roquette Frères
Terephthalic acid (99+% purity) from Acros
Irganox® 1010 from BASF AG
Dibutyltin oxide (98% purity) from Sigma-Aldrich

### Example 1: Preparation of a Semicrystalline Thermoplastic Polyester P1 and Use for Bottle Production

### A: Polymerization

1432 g (9.9 mol) of 1,4-cyclohexanedimethanol, 484 g (3.3 mol) of isosorbide, 2000 g (12.0 mol) of terephthalic acid, 1.65 g of Irganox 1010 (antioxidant) and 1.39 g of dibutyltin oxide (catalyst) are added to a 7.5 l reactor. To extract the residual oxygen from the isosorbide crystals, 4 vacuum-nitrogen cycles are carried out once the temperature of the reaction medium is between 60 and 80° C.

The reaction mixture is then heated to 275° C. (4° C./min) under 6.6 bar of pressure and with constant stirring (150 rpm) until a degree of esterification of 87% is obtained. The degree of esterification is estimated from the mass of distillate collected. The pressure is then reduced to 0.7 mbar over the course of 90 minutes according to a logarithmic gradient and the temperature is brought to 285° C.

These vacuum and temperature conditions were maintained until an increase in torque of 12.1 Nm relative to the initial torque is obtained.

Finally, a polymer rod is cast via the bottom valve of the reactor, cooled to 15° C. in a heat-regulated water bath and chopped in the form of granules of about 15 mg.

The resin thus obtained has a reduced solution viscosity of 80.1 ml/g.

The ¹H NMR analysis of the polyester shows that the final polyester contains 17.0 mol % of isosorbide relative to the diols.

With regard to the thermal properties, the polyester P1 has a glass transition temperature of 96° C., a melting point of 253° C. with an enthalpy of fusion of 23.2 J/g.

### B: Injection Biaxial Stretch Blow Molding in Mold

The granules of polyester P1 obtained in the polymerization step A are vacuum-dried at 140° C. for 3 h in order to achieve a residual moisture content of less than 300 ppm; in this example, the residual moisture content of the granules is 134 ppm.

The injection is carried out on a Husky single-cavity press with shutters.

The granules, kept under anhydrous conditions, are then introduced into the hopper of the injection press in order to obtain the preforms.

The injection parameters are detailed in table 1 below:

TABLE 1

| Parameters | Units | Value |
|---|---|---|
| Introduction zone temperature | ° C. | 230 |
| Temperature of the molten | ° C. | 285/280/280/270 |
| plastic (nozzle/tube) | | |
| Mold temperature | ° C. | 50 |
| Injection speed | mm/s | 80 |
| Holding pressure | bar | 29 |
| Holding time | s | 20 |
| Cooling time | s | 20 |

The preforms obtained from the polyester P1 have a weight of about 23 g after injection and have a reinforced neck specific to hot filling.

The preforms thus injected are then blow molded in a blow-molding carousel of the SBO series 2 brand from the company Sidel: BO ratio 11.51:3.59 in the radial direction and 3.20 in the axial direction with a rate of 1550 bottles/hour/mold.

For the blow molding in the carousel, the latter exhibits preheating of the preforms at 150° C. to the core using infrared lamps in the thermal conditioning zone under a stream of air at ambient temperature. The preform is placed in the mold which is at a temperature of 170° C. and the latter is then closed again.

The compressed air is injected via a tube which ensures biaxial stretching of the bottle.

Removal from the mold is carried out automatically and a biaxially stretched bottle is obtained at the carousel outlet.

The bottles thus formed have a uniform distribution of material and a volume of 500 ml.

### Example 2: Preparation of a Semicrystalline Thermoplastic Polyester P2 and Use for Bottle Production

A second semicrystalline thermoplastic polyester for use according to the invention was also prepared. The protocol is described below. Unlike the polyester P1, this polyester P2 has undergone a step of increasing molar mass by post-condensation.

### A: Polymerization

1194 g (8.3 mol) of 1,4-cyclohexanedimethanol, 726 g (5.0 mol) of isosorbide, 2000 g (12.0 mol) of terephthalic acid, 1.65 g of Irganox 1010 (antioxidant) and 1.39 g of dibutyltin oxide (catalyst) are added to a 7.5 l reactor. To extract the residual oxygen from the isosorbide crystals, four vacuum-nitrogen cycles are performed once the temperature of the reaction medium is between 60° C. and 80° C. The reaction mixture is then heated to 275° C. (4° C./min) under 6.6 bar of pressure and with constant stirring (150 rpm). The degree of esterification is estimated from the amount of distillate collected. The pressure is then reduced to 0.7 mbar over the course of 90 minutes according to a logarithmic gradient and the temperature is brought to 285° C.

These vacuum and temperature conditions were maintained until an increase in torque of 11.1 Nm relative to the initial torque is obtained.

Finally, a polymer rod is cast via the bottom valve of the reactor, cooled to 15° C. in a heat-regulated water bath and chopped in the form of granules of about 15 mg.

The resin thus obtained has a reduced solution viscosity of 66.2 ml/g⁻¹.

The ¹H NMR analysis of the polyester shows that the final polyester contains 30.2 mol % of isosorbide relative to the diols.

The granules were then crystallized for 5 hours at a temperature of 150° C. under nitrogen, then a solid-state post-condensation step was carried out on 25 kg of these granules for 20 h at 210° C. under a stream of nitrogen (1500 l/h) in order to increase the molar mass of these granules The resin after solid state condensation has a reduced solution viscosity of 94 ml·g⁻¹.

With regard to the thermal properties, the polyester P2 has a glass transition temperature of 113° C., a melting point of 230° C. with an enthalpy of fusion of 22 J/g.

### B—Injection Biaxial-Stretch Blow Molding in Mold

The granules of polyester P2 obtained in the polymerization step A are vacuum-dried at 140° C. in order to achieve a residual moisture content of less than 300 ppm; in this example, the residual moisture content of the granules is 172 ppm.

The injection is carried out on a Husky single-cavity press with shutters.

The granules, kept under anhydrous conditions, are introduced into the hopper of the injection press in order to obtain the preforms.

The other steps are similar to those of example 1, with the exception of modifications in the injection parameters, wherein the tube temperatures are slightly higher.

The injection parameters are detailed in table 2 below:

TABLE 2

| Parameters | Units | Value |
|---|---|---|
| Introduction zone temperature | ° C. | 230 |
| Temperature of the molten plastic | ° C. | 275/270/270/260 |
| (nozzle/tube) | | |
| Mold temperature | ° C. | 50 |
| Injection speed | mm/s | 80 |
| Holding pressure | bar | 35 |
| Holding time | s | 15 |
| Cooling time | s | 20 |

The preforms obtained from the polyester P2 have a weight of about 23 g after injection and have a reinforced neck specific to hot filling.

The preforms thus injected are then blow molded in a blow-molding carousel of the SBO series 2 brand from the company Sidel: BO ratio 11.51:3.59 in the radial direction and 3.20 in the axial direction with a rate of 1550 bottles/hour/mold and a mold temperature of 170° C.

For the blow molding in the carousel, the latter exhibits preheating of the preforms at 140° C. to the core using infrared lamps in the thermal conditioning zone under a stream of air at ambient temperature. The preform is placed in the mold which is at a mold temperature of 170° C. and the latter is then closed again. The compressed air is injected via a tube which ensures biaxial stretching of the bottle.

Removal from the mold is carried out automatically and a biaxially stretched bottle is obtained at the carousel outlet.

The bottles thus formed have a uniform distribution of material and a volume of 500 ml.

### Example 3: Preparation of an Amorphous Thermoplastic Polyester P3 and Use for Bottle Production by Extrusion-Blow Molding

Unlike the polyesters P1 and P2, the polyester P3 is a polyester which serves as a comparison and thus has an [A]/([A]+[B]) molar ratio of 0.44.

### A: Polymerization

859 g (6 mol) of 1,4-cyclohexanedimethanol, 871 g (6 mol) of isosorbide, 1800 g (10.8 mol) of terephthalic acid, 1.5 g of Irganox 1010 (antioxidant) and 1.23 g of dibutyltin oxide (catalyst) are added to a 7.5 l reactor. To extract the residual oxygen from the isosorbide crystals, 4 vacuum-nitrogen cycles are carried out once the temperature of the reaction medium is between 60 and 80° C.

The reaction mixture is then heated to 275° C. (4° C./min) under 6.6 bar of pressure and with constant stirring (150 rpm). The degree of esterification is estimated from the amount of distillate collected. The pressure is then reduced to 0.7 mbar over 90 minutes following a logarithmic ramp and the temperature is brought to 285° C. These vacuum and temperature conditions were maintained until an increase in torque of 10 Nm relative to the initial torque was obtained. Finally, a polymer rod is cast via the bottom valve of the reactor, cooled to 15° C. in a heat-regulated water bath and chopped in the form of granules of about 15 mg.

The resin thus obtained with this polyester P3 has a reduced solution viscosity of 54.9 ml/g.

The ¹H NMR analysis of the polyester shows that the final polyester contains 44 mol % of isosorbide relative to the diols. With regard to the thermal properties (measured at the second heating), the polymer has a glass transition temperature of 125° C.

### B: Production of Hollow Bodies by Parison Extrusion

The granules of the polyester P3 obtained in the polymerization step A are vacuum-dried at 110° C. in order to achieve residual moisture contents of less than 300 ppm; in this example, the water content of the granules is 230 ppm. The granules, kept in a dry atmosphere, are introduced into the hopper of the extruder.

The extrusion is carried out on a HESTA HV200 extrusion blow-molding machine, and the settings are assembled in table 3 below:

TABLE 3

| Name | Units | Values |
|---|---|---|
| Temperature of the plastic in | ° C. | 250/250/260/260/270/270 |
| the melt state (extruder/die) | | |
| Mold temperature | ° C. | 50 |
| Injection speed | rpm | 100 |
| Blowing time | sec | 7 |
| Control time | S | 1 |
| Permissible pressure drop | mbar | 5 |
| Cycle time | S | 15 |
| Production rate | Hollow | 240 |
| | bodies/hour | |

By virtue of an annular die, a parison is continuously extruded. The mold closes around the parison, a blade cuts the parison at the top of the mold, thus forming the preform and the latter is transferred to a second work station.

At that time, a blow pin injects compressed air into the preform in order to biaxially stretch it and to press it against the walls of the mold.

Finally, after opening the mold, the part is ejected and the mold returns to its initial position and closes around a new preform.

The amorphous hollow body thus formed has a weight of 23 g, and the absence of X-ray diffraction lines clearly confirms its amorphous nature.

### Example 4: Test for Hot Filling of Bottles Obtained with the Semicrystalline Thermoplastic Polyesters P 1 and P2 and the Amorphous Thermoplastic Polyester P3 (Comparative)

A: Hot Filling with Water at 90° C.

The bottles obtained by blow molding from the preforms produced with the polyesters P1 and P2 were hot-filled with water at a temperature of 90° C., with the objective being a dimensional deformation of less than at most 2%.

The dimensional stability is measured by measuring the diameter and the height at three points: neck, centre and base of the hollow body, before filling and 24 h after hot filling. The percentage corresponds to a deformation mean on each of these dimensions.

In the case of the polyester P3, the bottle undergoes deformations and a collapse as soon as the first volumes of liquid at 90° C. are introduced. It was not therefore possible to perform hot filling on the bottle consisting of the polymer P3.

The measurements show that the bottles produced from the polyesters P1 and P2 exhibit a dimensional deformation of less than 1% after filling.

The thermoplastic polyesters according to the invention are therefore particularly advantageous for use in the production of biaxially stretched hollow bodies, in particular bottles, requiring good resistance to deformation during hot filling.

B: Hot Filling with Oil at 105° C.

The bottles obtained by blow molding from the preforms produced with the polyesters P1, P2 and P3 were hot-filled with oil at a temperature of 105° C., with the objective being a dimensional deformation of less than at most 2%.

The bottles obtained with the polyesters P1 and P3 undergo deformations and collapse as soon as the first volumes of liquid at 105° C. are introduced.

This is explained by the fact that the glass transition temperature of the polyester P1 is lower than the temperature of the oil used for the filling and by the fact that the polyester P3 is an amorphous polyester. Thus, it was not therefore possible to obtain a dimensional deformation of less than 2% for the bottles obtained from the polyesters P1 and P3 during hot filling at 105° C.

Conversely, the measurements show that the bottles produced from the polyester P2 exhibit a dimensional deformation of less than 1.3% after filling.

The thermoplastic polyesters according to the invention are therefore particularly advantageous for use in the production of biaxially stretched hollow bodies, in particular bottles, requiring good resistance to deformation during hot filling.

### Example 5: Preparation of a Semicrystalline Thermoplastic Polyester and Use for Production of a Bottle

### A: Preparation

A fourth semicrystalline polyester P4 according to the invention was prepared according to the same procedure as example 1. The amounts of the various compounds were adjusted so as to obtain the polyester P4 having 25 mol % of isosorbide.

The amounts were determined by ¹H NMR and are expressed as percentage relative to the total amount of diols in the polyester.

The reduced solution viscosity of the polyester P4 is 79 ml/g.

### B—Forming of the Bottle by Injection Stretch Blow Molding (ISBM)

The granules of the polyester P4 obtained in the polymerization step A are then dried before injection for 6 h at 150° C. and thus have a moisture content of 0.129% by weight.

The injection is carried out on a Husky single-cavity press with shutters.

The granules, kept under anhydrous conditions, are introduced into the hopper of the injection press and the injection parameters are detailed in table 4 below:

TABLE 4

| Parameters | Units | Values |
|---|---|---|
| Screw diameter | mm | 35 |
| L/D Ratio | / | 23 |
| Injection temperature | ° C. | 290/280/270/ |
| (nozzle/tube) | | 260/250 |
| Mold temperature | ° C. | 50 |
| Loading speed | mm/s | 100 |
| Injection speed | cm³/s | 40/128 |
| Injection pressure | bar | 1250 |
| Holding pressure | bar | 900 |
| Backpressure | bar | 75 |
| Holding time | s | 15 |
| Cooling time | s | 12 |

After the injection, the preforms obtained have a weight of 23.7 g and have a reinforced neck specific to hot filling.

The preforms produced were then blow molded in a mold in order to obtain 0.5 I bottles. The machine used for the blow molding has the general characteristics below:

| Characteristics | Values |
|---|---|
| Maximum product volume | 2.5-5 l |
| Maximum preform height | 200 mm |
| Preform wall thickness | 1-4 mm |
| Maximum product diameter | 170 mm |
| Maximum product height | 350 mm |
| Production capacity | 500-800 Units/hour |

The blow molding of the preforms was then carried out according to the following parameters:

| Parameters | Values |
|---|---|
| Soft temperature | 86° C. |
| Mold temperature | 25° C. |
| Stretch delay | 0.05 s |
| Blow delay | 0.2 s |
| First blow molding | 0.3 s |
| Second blow molding | 4 s |
| Discharge | 1 s |

The bottles obtained have a uniform appearance and no surface deformation is observed with the naked eye.

C: Hot Filling with Water at 90° C.

The bottles are hot-filled with water at a temperature of 90° C., with the objective being to obtain dimensional deformation of less than at most 2%.

As in the preceding examples, the dimensional stability is measured by measuring the diameter and the height at three points: neck, centre and base of the hollow body, before filling and 24 h after hot filling. The percentage corresponds to a deformation mean on each of these dimensions.

The measurements show that the bottles produced from the polyester P4 exhibit a dimensional deformation of less than 1% after filling.

This example again demonstrates that the thermoplastic polyesters according to the invention are particularly advantageous for use in the production of biaxially stretched hollow bodies when it is necessary to obtain good resistance to deformation during hot filling.

1-19. (canceled)

20. Biaxially stretched hollow bodies comprising a semicrystalline thermoplastic polyester comprising:
at least one 1,4:3,6-dianhydrohexitol unit (A);
at least one alicyclic diol unit (B) other than the 1,4:3,6-dianhydrohexitol units (A);
at least one terephthalic acid unit (C);
wherein the (A)/[(A)+(B)] molar ratio is at least 0.05 and at most 0.30;
said polyester not containing any aliphatic non-cyclic diol units or comprising a molar amount of aliphatic non-cyclic diol units, relative to all the monomer units of the polyester, of less than 5%, and the reduced solution viscosity (25° C.; phenol (50% m): ortho-dichlorobenzene (50% m); 5 g/l of polyester) of said polyester being greater than 50 ml/g.

21. The biaxially stretched hollow bodies according to claim 20, wherein the alicyclic diol (B) is a diol chosen from 1,4-cyclohexanedimethanol, 1,2-cyclohexanedimethanol, 1,3-cyclohexanedimethanol or a mixture of these diols, very preferentially 1,4-cyclohexanedimethanol.

22. The biaxially stretched hollow bodies according to claim 20, wherein the 1,4:3,6-dianhydrohexitol (A) is isosorbide.

23. The biaxially stretched hollow bodies according to claim 20, wherein the polyester does not contain any aliphatic non-cyclic diol units, or comprises a molar amount of aliphatic non-cyclic diol units, relative to all the monomer units of the polyester, of less than 1%.

24. The biaxially stretched hollow bodies according to claim 20, wherein the (3,6-dianhydrohexitol unit (A)+alicyclic diol unit (B) other than the 1,4:3,6-dianhydrohexitol units (A))/(terephthalic acid unit (C)) molar ratio is from 1.05 to 1.5.

25. The biaxially stretched hollow bodies according to claim 20, wherein it also comprises one or more additional polymers and/or one or more additives.

26. A method for the production of a biaxially stretched hollow bodies, comprising the following steps of:
provision of a semicrystalline thermoplastic polyester comprising at least one 1,4:3,6-dianhydrohexitol unit (A), at least one alicyclic diol unit (B) other than the 1,4:3,6-dianhydrohexitol units (A), at least one terephthalic acid unit (C), wherein the (A)/[(A)+(B)] molar ratio is at least 0.05 and at most 0.30, said polyester not containing any aliphatic non-cyclic diol units or comprising a molar amount of aliphatic non-cyclic diol units, relative to all the monomer units of the polyester, of less than 5%, and the reduced solution viscosity (25° C.; phenol (50% m): ortho-dichlorobenzene (50% m); 5 g/l of polyester) of said polyester being greater than 50 mi/g;
preparation of said biaxially oriented hollow body from the semicrystalline thermoplastic polyester obtained in the preceding step

27. The method according to claim 26, wherein the preparation step is carried out by extrusion biaxial-stretch blow molding or by injection stretch blow molding.

28. The method according to claim 26, wherein the alicyclic diol (B) is a diol chosen from 1,4-cyclohexanedimethanol, 1,2-cyclohexanedimethanol, 1,3-cyclohexanedimethanol or a mixture of these diols.

29. The method according to claim 26, wherein the 1,4:3,6-dianhydrohexitol (A) is isosorbide.

30. The method according to claim 26, wherein the polyester does not contain any aliphatic non-cyclic diol units, or comprises a molar amount of aliphatic non-cyclic diol units, relative to all the monomer units of the polyester, of less than 1%.

31. The method according to claim 26, wherein the (3,6-dianhydrohexitol unit (A) +alicyclic diol unit (B) other than the 1,4:3,6-dianhydrohexitol units (A))/(terephthalic acid unit (C)) molar ratio is from 1.05 to 1.5.

32. The method according to claim 26, wherein the biaxially stretched hollow bodies comprises one or more additional polymers and/or one or more additives.
